(19) United States
(12) Patent Application Publication
(10) Pub. No.: US 2024/0197138 A1
(43) Pub. Date: Jun. 20, 2024

(54) HANDHELD CLEANING DEVICE

(71) Applicant: Graham Hayes, Lake Winnebago, MO (US)

(72) Inventor: Graham Hayes, Lake Winnebago, MO (US)

(21) Appl. No.: 18/083,132

(22) Filed: Dec. 16, 2022

(51) Int. Cl. A47L 13/12; A46B 5/00; A46B 5/02; A46B 13/02; A47L 13/16; A47L 13/24; A47L 13/42

(52) U.S. Cl. CPC A47L 13/12; A46B 5/0095; A46B 5/02; A46B 13/02; A47L 13/16; A47L 13/24; A47L 13/42

(57) ABSTRACT

A handheld cleaning device, including a main body to facilitate gripping thereof, and an attachment assembly, including a base detachably connected to at least a portion of the main body, a shaft disposed on at least a portion of the base to extend away from the base, a receiving head movably disposed on at least a portion of the shaft to receive at least one cleaning attachment thereon, and at least one motor movably disposed within at least a portion of the base to move at least one of the shaft and the receiving head in response to movement of the at least one motor.

### BACKGROUND

### 1. Field

The present general inventive concept relates generally to cleaning, and particularly, to a handheld cleaning device.

### 2. Description of the Related Art

Cleaning is a process to remove unwanted dirt, pathogens, and/or other contaminants from an environment and/or an object. Moreover, cleaning serves different purposes, such as maintaining hygiene, improving environmental appearance, and/or safety.

In most cases, cleaning is performed using multiple tools, such as a brush, a sponge, a mop, and/or towels. Thus, in order to adequately clean the environment and/or the object, a user will have to obtain and/or use multiple tools to finish the job. However, using multiple tools is time-consuming, inefficient, and can be expensive in addition to having to find space for storage.

Therefore, there is a need for a handheld cleaning that uses multiple attachments and can be adjusted for a variety of cleaning tasks.

### SUMMARY

The present general inventive concept provides a handheld cleaning device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a handheld cleaning device, including a main body to facilitate gripping thereof, and an attachment assembly, including a base detachably connected to at least a portion of the main body, a shaft disposed on at least a portion of the base to extend away from the base, a receiving head movably disposed on at least a portion of the shaft to receive at least one cleaning attachment thereon, and at least one motor movably disposed within at least a portion of the base to move at least one of the shaft and the receiving head in response to movement of the at least one motor.

The shaft may be perpendicularly disposed away from the base with respect to a direction.

The shaft may pivot in a first lateral direction or a second lateral direction over the base.

The receiving head may move clockwise in a first rotational direction or counterclockwise in a second rotational direction.

The receiving head may be distanced away from the shaft, such that the receiving head and the shaft have a gap therebetween.

The attachment assembly may further include a movable rod disposed within at least a portion of the shaft to connect the receiving head to the at least one motor.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a side perspective view of a handheld cleaning device, according to an exemplary embodiment of the present general inventive concept; and

FIG. 2 illustrates a sectional view of the handheld cleaning device, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Handheld Cleaning Device 100
Main Body 110
First Section 111
Second Section 112
Grip 113
Attachment Assembly 120
Base 121
Shaft 122
Receiving Head 123
Movable Rod 124
Motor 125
Body Connector 126
Speed Control Buttons 130
First Speed Button 131
Second Speed Button 132
Power Button 140
Power Source 150
Power Indicator 160

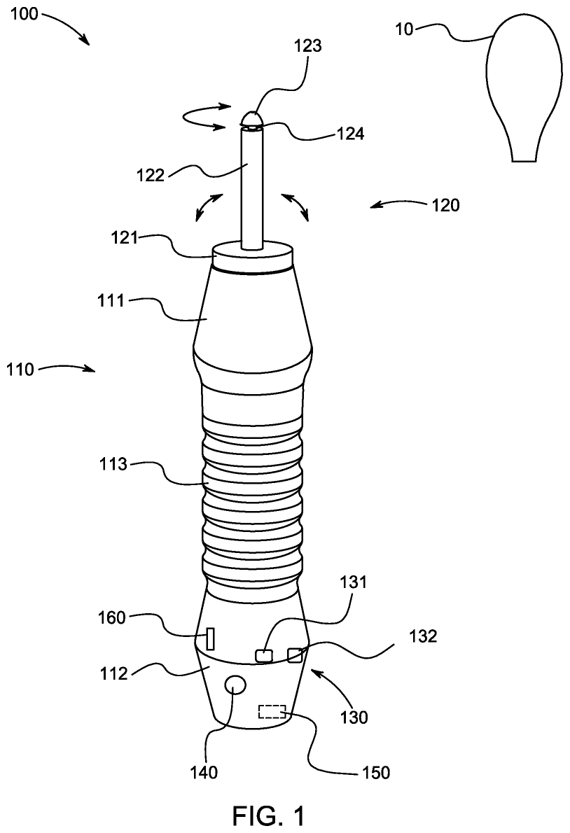

FIG. 1 illustrates a side perspective view of a handheld cleaning device 100, according to an exemplary embodiment of the present general inventive concept.

The handheld cleaning device 100 may be constructed from at least one of metal, plastic, wood, and rubber, etc., but is not limited thereto.

The handheld cleaning device 100 may include a main body 110, an attachment assembly 120, a plurality of speed control buttons 130, a power button 140, a power source 150, and a power indicator 160, but is not limited thereto.

The main body 110 may include a first section 111, a second section 112, and a grip 113, but is not limited thereto.

Referring to FIG. 1, the first section 111 and the second section 112 are illustrated to have a rounded and/or cylindrical shape. However, the first section 111 and the second section 112 may be rectangular, circular, conical, triangular, pentagonal, hexagonal, heptagonal, octagonal, or any other shape known to one of ordinary skill in the art, but is not limited thereto.

The first section 111 and/or the second section 112 may be elongate and be used as a handle.

The grip 113 may be a friction surface (e.g., a ribbed surface, a rubber surface, a knurled surface, a sandpaper surface). The grip 113 may be disposed between the first section 111 and/or the second section 112. Moreover, the grip 113 may facilitate gripping thereof.

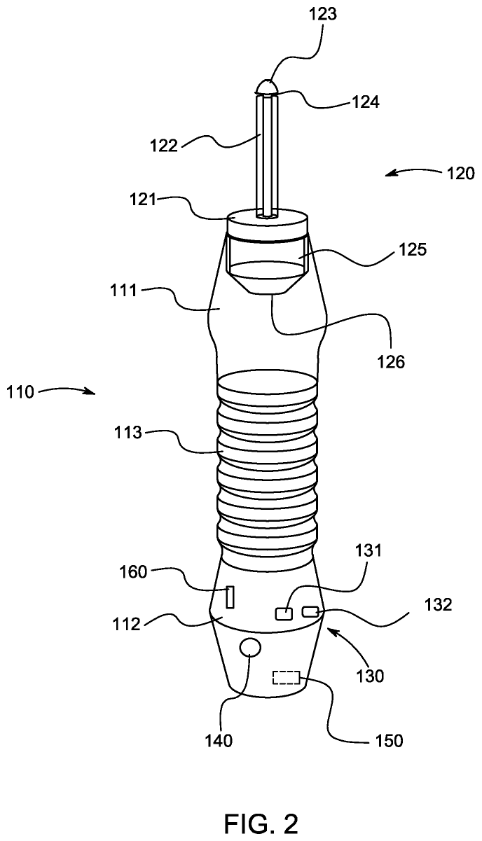

FIG. 2 illustrates a sectional view of the handheld cleaning device 100, according to an exemplary embodiment of the present general inventive concept.

Referring to FIG. 2, the attachment assembly 120 may include a base 121, a shaft 122, a receiving head 123, a movable rod 124, at least one motor 125, and a body connector 126, but is not limited thereto.

The base 121 may be detachably connected to at least a portion of the first section 111. More specifically, the base 121 may be inserted and/or connected (e.g., threadably connected) through an aperture on the first section 111.

The shaft 122 may be perpendicularly disposed at a first end away from the base 121 with respect to a direction. Additionally, the shaft 122 may move (i.e., pivot) in a first lateral direction and/or a second lateral direction over the base 121. Accordingly, the shaft 122 may move (i.e., pivot) one hundred eighty (180) degrees over the base 121.

The receiving head 123 may be semi-spherical in shape. The receiving head 123 may be movably (i.e., rotatably) disposed on at least a portion of a second end of the shaft 122. The receiving head 123 may move (i.e., rotate) clockwise in a first rotational direction. Conversely, the receiving head 123 may move counterclockwise in a second rotational direction. Moreover, the receiving head 123 may receive and/or connect to at least one cleaning attachment 10 (e.g., a brush, a broom, a mop, a sponge, etc.) thereon. The at least one cleaning attachment 10 may be exchanged and/or replaced for another at least one cleaning attachment 10 based on cleaning needs. Furthermore, the at least one cleaning attachment 10 may at least partially cover the shaft 122 and/or the base 121. It is important to note that the receiving head 123 may move (i.e., rotate) three hundred sixty (360) degrees in the first rotational direction or the second rotational direction.

Alternatively, the receiving head 123 may vibrate and/or oscillate (e.g., rotate back-and-forth in the first rotational direction and the second rotational direction) as needed for cleaning.

The receiving head 123 may be distanced away from the shaft 122, such that the receiving head 123 and/or the shaft 122 may have a gap therebetween. Thus, the gap may facilitate cleaning between the receiving head 123 and/or the shaft 122.

During use, the shaft 122 may move in the first lateral direction or the second lateral direction to move the at least one cleaning attachment 10 in at least one angular direction based on cleaning needs. Also, the receiving head 123 may move (i.e., rotate) in the first rotational direction or the second rotational direction to move the at least one cleaning attachment 10 based on the cleaning needs.

The movable rod 124 may be movably (i.e., rotatably) disposed within at least a portion of the shaft 122. The movable rod 124 may be disposed at a first end on at least a portion of the receiving head 123.

The at least one motor 125 may be movably (i.e., rotatably) disposed within at least a portion of the base 121 and/or connected to a second end of the movable rod 124. The shaft 122 and/or the receiving head 123 may move in response to movement of the at least one motor 125 via the movable rod 124. However, the shaft 122 and/or the receiving head 123 may move in response to an application of force (e.g., pushing, pulling).

The body connector 126 may be disposed on at least a portion of the base 121. The body connector 126 may connect the base 121 to an interior of the first section 111.

The plurality of speed control buttons 130 may include a first speed button 131 and a second speed button 132, but is not limited thereto.

The first speed button 131 may be disposed on at least a portion of the second section 112. The at least one motor 125 may increase a speed level in response to depressing the first speed button 131.

The second speed button 132 may be disposed on at least a portion of the second section 112. The at least one motor 125 may decrease the speed level in response to depressing the second speed button 132.

The at least one motor 125 may move (i.e., rotate) through a predetermined number of speed levels. For example, the at least one motor 125 may have a first speed level to clean fine oriental tableware, a second speed level to clean cabinets, a third speed level to clean dishes, a fourth speed level to clean carpet, and a fifth speed level to clean pans. In other words, the at least one motor 125 may use the first speed level (e.g., lowest) for delicate items and the fifth speed level (e.g., fastest) for items that are difficult to clean.

The power button 140 may be disposed on at least a portion of the second section 112. The power button 140 may turn on the attachment assembly 120 in response to being depressed a first time. Alternatively, the power button 140 may turn off the attachment assembly 120 in response to being depressed a second time.

Also, the power button 140 may change an operation setting of the receiving head 123. For example, the power button 140 may be depressed for a first predetermined period of time (e.g., two seconds) to rotate the receiving head 123 via the at least one motor 125, a second predetermined period of time (e.g., five seconds) to vibrate the receiving head 123 via the at least one motor 125, and/or a third period of time (e.g., seven seconds) to oscillate the receiving head 123 via the at least one motor 125.

The power source 150 may include a battery, a charge port, and a solar cell, but is not limited thereto.

The power source 150 may be disposed within at least a portion of the second section 112. The power source 150 may provide power to the attachment assembly 120, the plurality of speed control buttons 130, and the power button 140. The power source 150 may be charged by connecting to an external power source (e.g., a power outlet) using a charging cord connected to the charge port. Also, the battery of the power source 150 may be charged via the solar cell receiving light from an external light source.

The power indicator 160 may include at least one light (e.g., a light-emitting diode (LED), an incandescent bulb, a fluorescent bulb, etc.), but is not limited thereto.

The power indicator 160 may be disposed on at least a portion of the second section 112 and/or connected to the power source 150. The power indicator 160 may identify a power level of the power source 160. For example, the power indicator 160 may illuminate a first bar to indicate a low power level and needing to charge the power source 150. Additionally, the power indicator 160 may illuminate the first bar, a second bar, and/or a third bar to indicate a medium power level. Lastly, the power indicator 160 may illuminate the first bar, the second bar, the third bar, and/or a fourth bar to indicate a maximum (i.e., full) power level. The power source 150 having the maximum power level may operate for a predetermined period of time, such as thirty (30) minutes. However, any period of time (e.g., longer period of time) may be configured based on a preference of a user and/or a manufacturer.

Therefore, the handheld cleaning device 100 may be used for multiple cleaning tasks by interchanging the at least one cleaning attachment 10. Furthermore, the handheld cleaning device 100 may be used for different objects (e.g., tools), a vehicle (e.g., a car, a boat), and/or a building (e.g., a house).

The present general inventive concept may include a handheld cleaning device 100, including a main body 110 to facilitate gripping thereof, and an attachment assembly 120, including a base 121 detachably connected to at least a portion of the main body 110, a shaft 122 disposed on at least a portion of the base 121 to extend away from the base 121, a receiving head 123 movably disposed on at least a portion of the shaft 122 to receive at least one cleaning attachment 10 thereon, and at least one motor 125 movably disposed within at least a portion of the base 121 to move at least one of the shaft 122 and the receiving head 123 in response to movement of the at least one motor 125.

The shaft 122 may be perpendicularly disposed away from the base 121 with respect to a direction.

The shaft 122 may pivot in a first lateral direction or a second lateral direction over the base 121.

The receiving head 123 may move clockwise in a first rotational direction or counterclockwise in a second rotational direction.

The receiving head 123 may be distanced away from the shaft 122, such that the receiving head 123 and the shaft 122 have a gap therebetween.

The attachment assembly 120 may further include a movable rod 124 disposed within at least a portion of the shaft 122 to connect the receiving head 123 to the at least one motor 125.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A handheld cleaning device, comprising:
a main body to facilitate gripping thereof; and
an attachment assembly, comprising:
a base detachably connected to at least a portion of the main body,
a shaft disposed on at least a portion of the base to extend away from the base,
a receiving head movably disposed on at least a portion of the shaft to receive at least one cleaning attachment thereon, and
at least one motor movably disposed within at least a portion of the base to move at least one of the shaft and the receiving head in response to movement of the at least one motor.

2. The handheld cleaning device of claim 1, wherein the shaft is perpendicularly disposed away from the base with respect to a direction.

3. The handheld cleaning device of claim 1, wherein the shaft pivots in a first lateral direction or a second lateral direction over the base.

4. The handheld cleaning device of claim 1, wherein the receiving head moves clockwise in a first rotational direction or counterclockwise in a second rotational direction.

5. The handheld cleaning device of claim 1, wherein the receiving head is distanced away from the shaft, such that the receiving head and the shaft have a gap therebetween.

6. The handheld cleaning device of claim 1, wherein the attachment assembly further comprises:
a movable rod disposed within at least a portion of the shaft to connect the receiving head to the at least one motor.
